(19) United States
(12) Patent Application Publication
(10) Pub. No.: US 2025/0285075 A1
(43) Pub. Date: Sep. 11, 2025

(54) INVENTORY MANAGEMENT SYSTEM AND METHODS OF USE

(71) Applicant: COBALT EXTREME PTY LTD, Brisbane (AU)

(72) Inventor: David NOMMENSEN, Brisbane (AU)

(21) Appl. No.: 19/071,349

(22) Filed: Mar. 5, 2025

(30) Foreign Application Priority Data
Mar. 6, 2024 (AU) 2024900583

(51) Int. Cl. G06Q 10/087; E21B 41/00

(52) U.S. Cl. CPC G06Q 10/087; E21B 41/00

(57) ABSTRACT

A method for monitoring and/or tracking inventory items. The method includes applying a machine-readable identifier to a portion of an inventory item; storing one or more pieces of data relating to the inventory item at a first time in an electronic database and associating the one or more pieces of data with the identifier; reading the identifier at a second time and updating the electronic database with one or more pieces of additional data relating to the inventory item at the second time; comparing, using a computing device, the one or more pieces of data at the first time with the one or more additional pieces of data at the second time to generate information relating to performance characteristics of the inventory item; and making, based on the performance characteristics, one or more changes to a design of the inventory item to alter the performance of the inventory item.

### TECHNICAL FIELD

The present invention relates to a system and method for inventory management. In particular, the invention provides an inventory management system to effectively manage inventory assets used in downhole pumping systems.

### BACKGROUND

Today, organisations across various industries are constantly seeking ways to improve operational efficiencies and reduce costs. One area that often presents a significant opportunity for improvement is the management of equipment used in downhole pumping systems. These systems play a crucial role in well production programs, and the assets associated with them, such as sucker rods, tubing, and downhole pumping equipment, represent substantial investments.

However, the unplanned procurement of these assets can have severe financial implications. Owners and operators frequently find themselves burdened with unnecessary expenses in acquiring replacement equipment, leading to substantial financial losses each year. This financial strain not only impacts individual organisations but also affects the industry as a whole, undermining its overall profitability and competitiveness.

To address this challenge, there is a need for an innovative and comprehensive solution that can management of these critical assets. An advanced inventory management system and method tailored specifically to the needs of downhole pumping systems can offer substantial improvements.

Ideally, an effective inventory management system provides real-time visibility into asset availability, enabling proactive maintenance and timely replacement. This enhanced control not only prevents unnecessary expenses but also ensures uninterrupted well production, leading to improved operational efficiency and profitability.

Traditional inventory management systems often utilise RFID (Radio Frequency Identification) technology for scanning and tracking assets. These RFID tags are equipped with unique identification information that can be read by RFID readers or scanners. However, it is important to note that certain materials and environmental factors can interfere with the readability of RFID tags. Metals, liquids, and dense or conductive materials have the potential to attenuate or block the radio waves utilised in RFID communication. Consequently, this interference can compromise the accuracy of scanning and tracking processes, leading to potential inaccuracies or gaps in the inventory records.

In particular, when inventory items are utilised in downhole environments, the reliability of RFID tags becomes critical. These tags are susceptible to wear and tear, which may result in misidentification of asset records. Such misidentifications have the potential to cause costly downhole failures or lead to unnecessary inspections and repairs.

Therefore, it would be advantageous to develop an inventory management system specifically designed to handle the unique requirements of downhole assets used in challenging environments characterised by high temperatures, high pressures, and susceptibility to mechanical damage.

It will be clearly understood that, if a prior art publication is referred to herein, this reference does not constitute an admission that the publication forms part of the common general knowledge in the art in Australia or in any other country.

### SUMMARY OF INVENTION

Embodiments of the present invention provide an inventory management system and method of use for the management of downhole tools, which may at least partially address one or more of the problems or deficiencies mentioned above or which may provide the public with a useful or commercial choice.

Advantageously, the present invention provides a method and system for the management of downhole tools. This method and system offer a convenient approach to applying machine-readable identifiers to a protected portion of a downhole tool, ensuring its protection from environmental harm and long-term readability. Additionally, relevant inventory information is stored in an electronic database, allowing for efficient reading or updating of the pertinent data. Consequently, the invention establishes a high-performance inventory management system capable of effectively managing all downhole tools throughout their operational lifespan.

According to a first aspect of the present invention, there is provided a downhole tool for use in a gas or oil well, said downhole tool comprising:

an exposed portion configured to be exposed to environmental conditions during use,

a protected portion configured to be substantially protected from environmental conditions during use, and

a machine-readable identifier located on the protected portion of the downhole tool,

wherein one or more pieces of data relating to the downhole tool are associated with the identifier.

Downhole tools can be any downhole equipment that is used in the exploration, production, and maintenance of oil, gas, and geothermal wells. In particular, these tools are specifically designed to operate in the downhole environment, which is the area within the wellbore below the surface. Downhole tools may be any suitable equipment, such as tubing, casing, downhole pumps, packers, logging tools, perforating guns, drill bits, sucker rods and so on.

In a preferred embodiment, a downhole tool may be designed with both an exposed portion and a protected portion. The exposed portion refers to the part of the tool that is directly exposed to the downhole environment and is exposed to environmental conditions during use. In contrast, the protected portion is specifically engineered to be shielded or isolated from the surrounding environmental conditions, providing a high degree of protection during use.

Downhole tools are often used in the downhole environment with high pressure, high temperature and mechanical stresses.

The environmental conditions to which the downhole tool is exposed may include varying levels of pressure, which increase with depth.

The pressure may be generated due to the weight of the overlying rock layers increasing when the downhole tools drill deeper into the earth's subsurface, exerting pressure on the formations below. The weight of the rocks compresses the fluids and formations, resulting in elevated pressures.

Alternatively, the pressure may be generated due to the presence of hydrocarbons or geothermal fluids trapped within porous rock formations. The pressure within the reservoir may be driven by factors such as the depth of the reservoir, the amount of fluid present, and the geologic conditions.

Further, the pressure may be generated due to thermal expansion, such that when fluids are exposed to higher temperatures in the downhole environment, they may expand, leading to increased pressure.

The environmental conditions may also include elevated temperatures. Temperatures in the downhole environment usually increase with depth. Deep wells may experience extreme temperatures, ranging from moderate to extremely high levels. For instance, the bottom hole temperature of some wells may exceed 100°, or even 150°.

The high temperature in a well may be generated by geothermal energy or reservoir heat.

Alternatively, the heat may be generated during the drilling operations. For instance, drilling through rock formations may create friction between the drill bit and the formation, and this friction generates heat.

It is also possible that the heat may be generated due to certain exothermic chemical reactions.

The environmental conditions may further result in mechanical damage to the downhole tools.

For example, vibrations may be caused by the operation of the downhole pumping system or other equipment, and can lead to fatigue, wear, and potential failure of components over time. Because the downhole tools come into contact with the surrounding formations, casing, or other equipment, there may be friction and abrasion therebetween, leading to mechanical damage to the downhole tools.

Downhole tools may experience sudden impacts or shocks due to various reasons, such as tool deployment, operation, or handling. They may also be subject to high compression or tension forces, due to the weight of the formations, pressure differentials, or mechanical forces during operation.

Further, the environment within a well may be corrosive. A corrosive environment may be generated through the use of chemicals used in the well, or interactions between water and gases in the well and chemicals used in the process. These corrosive conditions may lead to damage to downhole tools over time.

The exposed portion of the downhole tools may be any portion of the downhole tools, depending on the type of downhole equipment and its intended purpose. However, it will be understood that the exposed portion is the portion of the downhole tool that is exposed to, and comes into contact with, the environmental conditions within the well. Thus, the exposed portion of the downhole tool may be adversely affected by the environmental conditions within the well.

In one embodiment, the exposed portion of the downhole tool may be a tubing or a casing that is configured to be inserted into the wellbore, extending from the surface down to the desired depth. This exposed portion is in direct contact with the surrounding formations and fluids.

In another embodiment, the exposed portion may include the pump mechanism, such as a sucker rod pump or an electric submersible pump. This portion operates within the wellbore, interacting with the fluid and lifting or pushing it to the surface.

In yet another embodiment, the exposed portion may comprise one or more sensors, detectors, or probes that are in direct contact with the formations or fluids, enabling the measurement and recording of relevant data.

If the downhole tool is a perforating gun, its exposed portion may include the charges or explosives that are positioned against the wellbore wall to create perforations. It will be understood that the perforations may be created in a casing or tubing. Alternatively, if the downhole tool is a drill bit, its exposed portion is the cutting structure that is configured to come into contact with one or more formations being drilled.

The exposed portion may be formed from any suitable material or materials.

It is envisaged that the protected portion of the downhole tool may be specifically designed to be shielded or isolated from the downhole environment during its use in a wellbore. The protected portion may vary depending on the type of downhole tool and its design considerations.

In one embodiment, the protected portion of downhole tools, such as packers or valves, may comprise one or more seals and/or isolation mechanisms configured to create a barrier. The barrier may be configured to reduce or preclude the intrusion of well fluids, formation debris, or contaminants into internal components of the downhole tool.

In another embodiment, the protected portion of downhole tools, such as casing or tubing, may be the portion that features protective coatings or claddings that provide corrosion resistance, erosion resistance, or resistance to chemical attack, extending the equipment's lifespan and maintaining its structural integrity.

In yet another embodiment, the protected portion of downhole tools may be the portion that is covered by a housing or casing which serves as a physical barrier, shielding the internal components from direct exposure to the downhole environment and providing structural support and protection against mechanical damage.

In a further embodiment, the protected portion of the downhole equipment may be a connection portion. The connection portion may be of any suitable form, such as a screw thread, coupling or the like. In embodiments of the invention in which the protected portion comprises a screw-threaded portion of the downhole tool, it is envisaged that, when the screw-threaded portion is connected to another part, such as a coupling, joint or complementary screw-threaded portion, the thread itself is effectively protected from the surrounding downhole environment.

As indicated, a machine-readable identifier is located on the protected portion of the downhole tool.

The machine-readable identifier may take various forms, depending on the specific implementation and requirements of the inventory management system.

In one embodiment, the machine-readable identifier may be a two-dimensional identifier, such as a barcode which is a graphical representation of data and can be scanned and interpreted by barcode readers or scanners. It often consists of a series of parallel lines of varying widths, encoding information such as a unique identifier or product details. Common barcodes may be Code 128 which can encode a full 128 ASCII character set or Code 39 which encodes 39 characters in total. Barcodes may be printed or engraved on the surface of the downhole tool, allowing for easy scanning and identification.

In another embodiment, the machine-readable identifier may be a QR (Quick Response) code which is a two-dimensional barcode that can store more information compared to traditional barcodes. QR codes can be scanned using smartphones or specialised QR code readers. They can be applied to the downhole tool's surface and contain relevant data or a link to an electronic database for comprehensive tool information.

In yet another embodiment, the machine-readable identifier may be RFID (Radio Frequency Identification) tags which are small electronic devices containing a unique identifier. RFID tags may be embedded or attached to the downhole tools, allowing for non-contact scanning and tracking of the tool's location and information.

In a further embodiment, the machine-readable identifier may be a data matrix code which is a two-dimensional barcode that can store a large amount of information in a compact space. It consists of black and white square modules arranged in a square or rectangular pattern. Data matrix codes can be printed or etched onto the downhole tools, enabling quick and accurate scanning with specialised readers.

In yet a further embodiment, the machine-readable identifier may be a serial number or alphanumeric code located on the surface of the downhole tool.

The machine-readable identifier may be located on the protected portion using any suitable technique. For instance, the machine-readable identifier may be located on a substrate (such as a paper, plastic or metallic substrate), and the substrate may be attached to the protected portion, such as through the use of adhesives, mechanical fasteners, joining techniques (such as welding and the like) and so on.

Alternatively, the machine-readable identifier may be directly applied to the surface of the downhole tool in the protected portion. The machine-readable identifier may be applied using any suitable technique, such as by printing, etching, engraving, deposition and so on. In a specific embodiment of the invention, the machine-readable identifier may be located on the surface of the downhole tool in the protect region by laser etching.

The machine-readable identifier may be applied to any suitable surface of the downhole tool in the protected portion. Preferably, the machine-readable identifier is located on a relatively smooth or planar surface. In some embodiments the protected portion may include a relatively smooth or planar surface. However, in other embodiments, a relatively smooth or planar surface may be formed on the protected portion. For instance, a portion of a screw thread may be removed, and the machine-readable identifier may be located on the surface of the protected portion from which the portion of the screw thread has been removed.

As indicated, one or more pieces of data relating to the downhole tool are associated with the machine-readable identifier. This association allows for easy retrieval and storage of relevant information about the downhole tool in an electronic database or inventory management system. The associated data may be any relevant information about the downhole tool.

In one embodiment, the associated data may be information relating to the specifications of the downhole tool. The specifications may be of any suitable form, and may include dimensions, materials, weight, rated capacity, manufacturer (including date and location of manufacture) or performance characteristics. This data may provide details about the design and capabilities of the downhole tool

In another embodiment, the associated data may be records of the maintenance, inspection, and servicing activities of the downhole tool. For example, it may include dates of installation or maintenance, details of performed tasks, and any repairs or replacements carried out. The data may further include the name(s) of the installer of the tool and/or the name(s) of any person who performed maintenance on the tool.

In yet another embodiment, the associated data may be certifications, compliance documentation, and quality assurance records. This data ensures that the downhole tool meets industry standards, regulatory requirements, and safety protocols if any.

In a further embodiment, the associated data may be the usage history of the downhole tool, such as the number of times it has been deployed, duration of use, or specific wells or projects where it has been employed. This data may provide insights into the tool's lifespan, usage patterns, and potential performance trends.

In yet a further embodiment, the associated data may be the ownership and inventory tracking of the downhole tool. This may include information about the tool's current location, owner, responsible personnel, and any transfers or changes in ownership.

It is envisioned that the associated data may encompass any form or combination of the aforementioned embodiments.

According to a second aspect of the present invention, there is provided a method for monitoring and/or tracking inventory items, the method comprising:
a) applying a machine-readable identifier to a portion of an inventory item that, in use, is substantially protected from environmental conditions;
b) storing one or more pieces of data relating to the inventory item at a first time in an electronic database and associating the one or more pieces of data with the identifier;
c) reading the identifier at a second time subsequent to the first time and updating the electronic database with one or more pieces of additional data relating to the inventory item at the second time;
d) comparing, using a computing device, the one or more pieces of data at the first time with the one or more additional pieces of data at the second time to generate information relating to performance characteristics of the inventory item; and
e) making, based on the performance characteristics, one or more changes to a design of the inventory item to alter the performance of the inventory item.

As indicated, there is provided a method for monitoring and/or tracking inventory items, such as downhole tools.

A machine-readable identifier may be applied to any suitable area of the inventory item. Preferably the identifier is to be applied to a protected portion of the inventory item, such that it is protected from various environmental conditions.

The machine-readable identifier may be applied to the inventory item using any suitable method. It is envisaged that the machine-readable identifier must be generated before being applied to the downhole tools.

In a preferred embodiment of the invention, the inventory item of the second aspect of the invention may comprise the downhole tool of the first aspect of the invention.

In the case that the machine-readable identifier is a barcode (such as Code 128 or Code 39) or a QR code, the generated code image may be first printed onto a suitable label or tag material, and then attached to the inventory item.

Alternatively, the barcode or QR code may be directly printed on the surface of the inventory item using any suitable printing method.

In one embodiment, the barcode or QR code may be printed onto the inventory item using a method of laser etching or marking. For example, a laser beam may be used to remove or discolour the surface material, creating high-contrast barcode or QR code patterns. This method ensures durability and longevity, as the code image becomes an integral part of the tool's surface.

In another embodiment, the barcode or QR code may be printed onto the inventory item using a method of dot peening which is a process where a series of tiny dots are indented onto the surface of the downhole tools. The dots form the barcode or QR code pattern. Usually, the depth and spacing between the dots determine the readability of the barcode or QR code. Dot peening is often suitable for harsh environments.

In yet another embodiment, the barcode or QR code may be printed onto the inventory item using inkjet printing. During the printing, the printer sprays ink droplets onto its surface, creating the barcode or QR code pattern.

In a further embodiment, the barcode or QR code may be printed onto the surface of the inventory item using chemical etching.

It is envisaged that the barcode or QR code may be printed onto the inventory item using any abovementioned method or any form of a combination of them.

In the case that the machine-readable identifier is an RFID tag, it may be attached to the inventory item in any suitable method.

In one embodiment, the RFID tags may have adhesive backing which can be readily adhered to the downhole tool.

In another embodiment, the RFID tags may be attached to the downhole tool using any suitable attachment mechanisms such as screws, bolts, straps, or clamps.

In yet another embodiment, the RFID tags may be welded onto the surface of the downhole tool.

It is envisaged that any additional measures such as epoxy or sealants may be used if extra security is needed.

In the case that the machine-readable identifier is a serial number or alphanumeric code, it may be applied to the inventory item in any suitable method, such as engraving, stamping, labelling, inkjet or thermal transfer printing, and etching or chemical marking.

One or more pieces of data relating to the inventory item may be stored in an electronic database. The electronic database may be a relational database management system such as MySQL or Oracle, or a NoSQL database such as MongoDB or Cassandra. Further, the electronic database may be set up either locally or on the cloud.

Before storing data in the electronic database, it may be necessary to determine the structure and fields of the database that will hold the inventory data. It is also preferably to identify the specific pieces of data that need to be stored for each inventory item, such as serial number, description, specifications, maintenance history, or any other relevant information.

In order to store the data relating to an inventory item, it is usually to generate or assign a unique identifier for the inventory item. The unique identifier may be a barcode, RFID tag number or alphanumeric code that is discussed above. It is anticipated that this identifier will serve as the key to associate one or more pieces of data with the respective inventory item.

The one or more pieces of data relating to the inventory item may be stored in the electronic database by any means. It may be done manually through a user interface or automated through integration with other systems, such as scanning devices and/or IoT sensors.

The one or more pieces of data relating to the inventory item will be linked to the unique identifier in the database. This may be achieved by creating a field in the database that stores the identifier as a reference for each inventory item. This linkage allows for easy retrieval and updating of the one or more pieces of data based on the unique identifier.

It is envisaged that necessary measures must be implemented to ensure data integrity and security within the electronic database. This may include but is not limited to data backups, access controls, encryption, and regular maintenance to safeguard the information and prevent unauthorised access or loss.

The first time to which the data relates may be any suitable time. For instance, the first time may be at the time of the manufacture of the inventory item. Alternatively, the first time may be at the time the inventory item is acquired by the user. Thus, the first time may be when the inventory item is first entered into the user's inventory system. In other embodiments, the first time may be at the time of the first use of the inventory item. In any event, it is envisaged that the first time may be at a point in time prior to the first usage of the inventory item.

As indicated, a machine-readable identifier may be applied to a protection portion of the downhole tool. To read the identifier, it may need to clear the access to the protection portion first.

In the case that the unique identifier is a barcode or a QR code, any barcode or QR code scanner device or a compatible mobile device with a built-in barcode or QR scanning capability may be used to read the unique identifier. However, it is necessary to position the inventory item so that its barcode or QR code is visible and accessible for scanning.

It is envisaged that during the scanning, the scanner device or a compatible mobile device may need to be maintained at a suitable distance and angle for accurate scanning.

Further, the scanning function may be manually triggered or automatically starts when the scanner device is in proximate to the machine-readable identifier. During the scanning, the scanner or mobile device will capture and decode the barcode or QR code to extract information, such as the identity of the inventory item or any additional data relating to the inventory item.

In the case that the unique identifier is an RFID tag, an RFID reader device may be used to read the machine-readable identifier attached to the inventory item.

Usually, the RFID reader needs to be positioned in close proximity to the RFID tag on the inventory item. The distance may depend on the RFID technology used (e.g., proximity, near-field, far-field).

Further, the RFID reader may be configured to the appropriate frequency and mode for reading the RFID tag. During the reading process, the RFID reader will be placed within range of the RFID tag on the inventory item. After being triggered manually or automatically, the reader may emit radio waves or electromagnetic fields to communicate with the tag. Then it may receive the response from the RFID tag, retrieving the encoded identifier associated with the downhole tool.

In the case that the unique identifier is a serial number or alphanumeric code, it can be read manually by human operators.

Alternatively, the unique identifier may be read through a mobile device such as a smartphone or tablet with a dedicated mobile application installed. For example, a picture or scan of the serial number or alphanumeric code on the tool is captured by the mobile device's camera, then the installed mobile application may utilise pattern recognition algorithms to recognise and extract the serial number or alphanumeric code from the downhole tool.

The second time may be at any suitable time subsequent to the first time. For instance, the second time may be when the inventory item is returned to storage after use. Alternatively, the second time may be during maintenance of the inventory item. In other embodiments of the invention, the second time may be upon replacement of the inventory item. In any event, it is envisaged that the second time may be at a point in time after the inventory item has been used.

In some embodiments, data relating to the inventory item may be collected on more occasions than the first time and the second time. For instance, the machine-readable identifier may be read every time maintenance of the inventory item occurs, or after every use. Thus, in some embodiments of the invention, data relating to the inventory item may be collected three or more times.

It is envisaged that one or more pieces of additional data relating to the inventory may include any relevant information such as maintenance records, inspection dates, usage history, location, or any other pertinent details.

Further, appropriate access rights and permissions may be required to update the electronic database and the database may be accessed through a user interface provided by an inventory management software.

The database may be updated via any suitable method. Typically, it may be necessary to first retrieve the existing data associated with the inventory equipment from the database by executing a database query based on the unique identifier to fetch the relevant data. Then, the retrieved data may be modified by incorporating the additional information. Third, the new or modified data may be securely stored in the database, linked to the corresponding inventory equipment. During the updating, it is necessary to ensure that the updates are accurate, consistent, and comply with any data validation or formatting requirements set by the database schema. Additional quality assurance measures may be performed to confirm that the changes have been successfully applied.

The performance characteristics of inventory tools may be any information regarding the properties or use of the inventory tools.

First, the performance characteristics of inventory tools may include the durability and strength information, such that the tool's ability to withstand repeated use, mechanical stress, vibrations, and impacts without experiencing deformation, breakage, or loss of functionality.

Second, the performance characteristics of inventory tools may also include their resistance to corrosion when exposed to corrosive substances, harsh environments, or chemical agents.

Third, the performance characteristics of inventory tools (such as pumps, valves or flow meters) may include their ability to handle a specific volume or rate of fluid or material flow.

Fourth, the performance characteristics of inventory tools may include their maintenance needs, including frequency, simplicity, or complexity of maintenance tasks, and availability of spare parts.

In addition, the performance characteristics of inventory tools may also include their operating temperature range, pressure rating, reliability and performance consistency, compatibility and interchangeability, efficiency and energy consumption and so on.

Performance characteristics may be calculated using any suitable method. Typically, for a particular inventory tool, it may be calculated by (1) defining metrics to calculate the performance characteristics; (2) comparing the one or more pieces of data at the first time with the one or more additional pieces of data at the second time; (3) processing and analysing the data; (4) applying the calculation metrics with the data; and then (5) generating the information of performance characteristics. It is envisaged that the specific methods used to calculate performance characteristics may vary depending on the nature of the tools and the metrics being evaluated.

The calculation may be carried out manually or by using a computing device which may be a device or machine capable of performing computational tasks, processing data, and executing software programs, such as personal computers, mobile devices, servers, embedded systems, wearable devices, gaming devices, cloud computing devices, supercomputers and so on.

In a preferred embodiment of the invention, a computing device may be used to calculate the performance characteristics of the inventory item. It is envisaged that the performance characteristics may be used to determine how the inventory item performed according to its original specifications. In other words, the computing device may be used to determine whether the inventory item performed as expected, better than expected, or worse than expected.

As indicated, one or more changes to the design of the inventory item may be made to alter the performance of the inventory item.

The design of the inventory item may be any aspect of the inventory item that can impact the performance, functionality, and reliability in downhole environments, including but not limited to material selection, structural design, sealing and pressure containment, connection mechanisms, compatibility and interchangeability, fluid flow dynamics, sensing and monitoring, durability and reliability, size and weight optimisation, and manufacturability. Thus, the one or more changes to the design of the inventory item may include changes to one or more aspects of material selection, structural design, sealing and pressure containment, connection mechanisms, compatibility and interchangeability, fluid flow dynamics, sensing and monitoring, durability and reliability, size and weight optimisation, and/or manufacturability.

These changes may be motivated by the performance characteristics achieved as mentioned above, as well as by various other commercial considerations. Typically, if the current design of the inventory item does not meet the desired performance objectives, or some failure analysis identifies the causes for failures, malfunctions or suboptimal performance, a change to the design of the inventory item may be performed to alter the performance characteristics of the inventory item.

Further, if the inventory item may be used in new applications or environments, or there are changes in the availability or performance of certain components or materials used in the inventory item, a change to the design of the inventory item may also be performed. It is envisaged that some change may be necessary due to market demands, competitive factors, customer feedback, cost-effectiveness, scalability, regulatory compliance, and emerging industry trends. In general, the decision to modify the design of the inventory item can be influenced by a combination of technical requirements and business objectives, aiming to optimise the overall value proposition and meet the evolving needs of the industry and end-users.

According to a third aspect of the present invention, there is provided a system for monitoring and/or tracking inventory items, said system comprising:

an application device configured to apply a machine-readable identifier to a portion of an inventory item that, in use, is substantially protected from environmental conditions;

an electronic database configured to store one or more pieces of data relating to the inventory item at a first time and associate the one or more pieces of data with the identifier;

a reading device configured to read the machine-readable identifier at a second time subsequent to the first time; and

a computing device configured to update the electronic database with one or more pieces of additional data relating to the inventory item at the second time and to compare the one or more pieces of data at the first time with the one or more additional pieces of data at the second time to generate information relating to performance characteristics of the inventory item,

wherein the computing device is further configured to make, based on the performance characteristics, one or more changes to a design of the inventory item to alter the performance of the inventory item.

Any suitable application device may be used to apply a machine-readable identifier to a portion of an inventory item.

In the case that the machine-readable identifier is a barcode or QR code, the application device may be a printer, engraving machine, etching machine, inkjet printer, label applicator, or direct part marking (DPM) system.

If the machine-readable identifier is an RFID tag, the application device may be an RFID tag applicator, RFID label printer or RFID Inlay embedding machine. As indicated, the common application methods include adhesive backing, heat shrink tubing, cable ties, epoxy bonding, or mechanical fasteners.

If the machine-readable identifier is a data matrix code, the application device may be a direct part marking (DPM) system or any suitable label printer.

If the machine-readable identifier is a serial number or alphanumeric code, the application device may be any suitable machine that can carry out dot peening, laser marking, engraving or chemical etching on the inventory item to apply the number or code.

Typically, the machine-readable identifier may be applied to a protected portion of an inventory item that is substantially protected from environmental conditions.

The electronic database is configured to store one or more pieces of data relating to the inventory item at a first time and associate the one or more pieces of data with the identifier. The electronic database may be a relational database management system such as MySQL or Oracle, or a NoSQL database such as MongoDB or Cassandra. Further, the electronic database may be set up either locally or on the cloud.

Before storing data in the electronic database, it may be necessary to determine the structure and fields of the database that will hold the inventory data. It is also preferably to identify the specific pieces of data that need to be stored for each inventory item, such as serial number, description, specifications, maintenance history, or any other relevant information.

In order to store the data relating to an inventory item, it is usually to generate or assign a unique identifier for the inventory item. The unique identifier may be a barcode, RFID tag number or alphanumeric code that is discussed above. It is anticipated that this identifier will serve as the key to associate one or more pieces of data with the respective inventory item.

The one or more pieces of data relating to the inventory item may be stored in the electronic database by any means. It may be done manually through a user interface or automated through integration with other systems, such as scanning devices or IoT sensors.

The one or more pieces of data relating to the inventory item will be linked to the unique identifier in the database. This may be achieved by creating a field in the database that stores the identifier as a reference for each inventory item. This linkage allows for easy retrieval and updating of the one or more pieces of data based on the unique identifier.

It is envisaged that necessary measures must be implemented to ensure data integrity and security within the electronic database. This may include but is not limited to data backups, access controls, encryption, and regular maintenance to safeguard the information and prevent unauthorised access or loss.

The first time to which the data relates may be any suitable time. For instance, the first time may be at the time of the manufacture of the inventory item. Alternatively, the first time may be at the time the inventory item is acquired by the user. Thus, the first time may be when the inventory item is first entered into the user's inventory system. In other embodiments, the first time may be at the time of the first use of the inventory item. In any event, it is envisaged that the first time may be at a point in time prior to the first usage of the inventory item.

A reading device is to read the machine-readable identifier at a second time subsequent to the first time. As indicated, a machine-readable identifier may be applied to a protection portion of the downhole tool. To read the identifier, it may need to clear the access to the protection portion first.

In the case that the unique identifier is a barcode or a QR code, any barcode or QR code scanner device or a compatible mobile device with a built-in barcode or QR scanning capability may be used to read the unique identifier. However, it is necessary to position the inventory item so that its barcode or QR code is visible and accessible for scanning.

It is envisaged that during the scanning, the scanner device or a compatible mobile device may need to be maintained at a suitable distance and angle for accurate scanning.

Further, the scanning function may be manually triggered or automatically starts when the scanner device is in proximate to the machine-readable identifier. During the scanning, the scanner or mobile device will capture and decode the barcode or QR code to extract information, such as the identity of the inventory item or any additional data relating to the inventory item.

In the case that the unique identifier is an RFID tag, an RFID reader device may be used to read the machine-readable identifier attached to the inventory item.

Usually, the RFID reader needs to be positioned in close proximity to the RFID tag on the inventory item. The distance may depend on the RFID technology used (e.g., proximity, near-field, far-field).

Further, the RFID reader may be configured to the appropriate frequency and mode for reading the RFID tag. During the reading process, the RFID reader will be placed within range of the RFID tag on the inventory item. After being triggered manually or automatically, the reader may emit radio waves or electromagnetic fields to communicate with the tag. Then it may receive the response from the RFID tag, retrieving the encoded identifier associated with the downhole tool.

In the case that the unique identifier is a serial number or alphanumeric code, it can be read manually by human operators.

Alternatively, the unique identifier may be read through a mobile device such as a smartphone or tablet with a dedicated mobile application installed. For example, a picture or scan of the serial number or alphanumeric code on the tool is captured by the mobile device's camera, then the installed mobile application may utilise pattern recognition algorithms to recognise and extract the serial number or alphanumeric code from the downhole tool.

The second time may be at any suitable time subsequent to the first time. For instance, the second time may be when the inventory item is returned to storage after use. Alternatively, the second time may be during maintenance of the inventory item. In other embodiments of the invention, the second time may be upon replacement of the inventory item. In any event, it is envisaged that the second time may be at a point in time after the inventory item has been used.

In some embodiments, data relating to the inventory item may be collected on more occasions than the first time and the second time. For instance, the machine-readable identifier may be read every time maintenance of the inventory item occurs, or after every use. Thus, in some embodiments of the invention, data relating to the inventory item may be collected three or more times.

A computing device is configured to update the electronic database with one or more pieces of additional data relating to the inventory item at the second time and to compare the one or more pieces of data at the first time with the one or more additional pieces of data at the second time to generate information relating to performance characteristics of the inventory item.

The calculation may be carried out manually or by using a computing device which may be a device or machine capable of performing computational tasks, processing data, and executing software programs, such as personal computers, mobile devices, servers, embedded systems, wearable devices, gaming devices, cloud computing devices, supercomputers and so on.

In a preferred embodiment of the invention, a computing device may be used to calculate the performance characteristics of the inventory item. It is envisaged that the performance characteristics may be used to determine how the inventory item performed according to its original specifications. In other words, the computing device may be used to determine whether the inventory item performed as expected, better than expected, or worse then expected.

The performance characteristics of inventory tools may be any information regarding to the properties or use of the inventory tools.

First, the performance characteristics of inventory tools may include the durability and strength information, such that the tool's ability to withstand repeated use, mechanical stress, vibrations, and impacts without experiencing deformation, breakage, or loss of functionality.

Second, the performance characteristics of inventory tools may also include their resistance to corrosion when exposed to corrosive substances, harsh environments, or chemical agents.

Third, the performance characteristics of inventory tools (such as pumps, valves or flow meters) may include their ability to handle a specific volume or rate of fluid or material flow.

Fourth, the performance characteristics of inventory tools may include their maintenance needs, including frequency, simplicity, or complexity of maintenance tasks, and availability of spare parts.

In addition, the performance characteristics of inventory tools may also include their operating temperature range, pressure rating, reliability and performance consistency, compatibility and interchangeability, efficiency and energy consumption and so on.

Performance characteristics may be calculated by a computing device using any suitable method. Typically, for a particular inventory tool, it may be calculated by (1) defining metrics to calculate the performance characteristics; (2) comparing the one or more pieces of data at the first time with the one or more additional pieces of data at the second time; (3) processing and analysing the data; (4) applying the calculation metrics with the data; and then (5) generating the information of performance characteristics. It is envisaged that the specific methods used to calculate performance characteristics may vary depending on the nature of the tools and the metrics being evaluated.

As indicated, the computing device is further configured to make, based on the performance characteristics, one or more changes to the design of the inventory item to alter the performance of the inventory item.

The design of the inventory item may be any aspect of the inventory that can impact the performance, functionality, and reliability in downhole environments, including but not limited to material selection, structural design, sealing and pressure containment, connection mechanisms, compatibility and interchangeability, fluid flow dynamics, sensing and monitoring, durability and reliability, size and weight optimisation, and manufacturability.

These changes may be motivated by the performance characteristics achieved as mentioned above, as well as by various other commercial considerations. Typically, if the current design of the inventory item does not meet the desired performance objectives, or some failure analysis identifies the causes for failures, malfunctions or suboptimal performance, a change to the design of the inventory item may be performed to alter the performance characteristics of the inventory item.

Further, if the inventory item may be used in new applications or environments, or there are changes in the availability or performance of certain components or materials used in the inventory item, a change to the design of the inventory item may also be performed. It is envisaged that some change may be necessary due to market demands, competitive factors, customer feedback, cost-effectiveness, scalability, regulatory compliance, and emerging industry trends. In general, the decision to modify the design of the inventory item can be influenced by a combination of technical requirements and business objectives, aiming to optimise the overall value proposition and meet the evolving needs of the industry and end-users.

Any of the features described herein can be combined in any combination with any one or more of the other features described herein within the scope of the invention.

The reference to any prior art in this specification is not and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 is a photograph showing a perspective view of part of a downhole tool according to an embodiment of the present invention;

FIG. 2 is also a photograph showing a perspective view of part of a downhole tool according to another embodiment of the present invention; and

FIG. 3 illustrates a flowchart of a method for monitoring and/or tracking inventory items according to an embodiment of the present invention.

### DETAILED DESCRIPTION

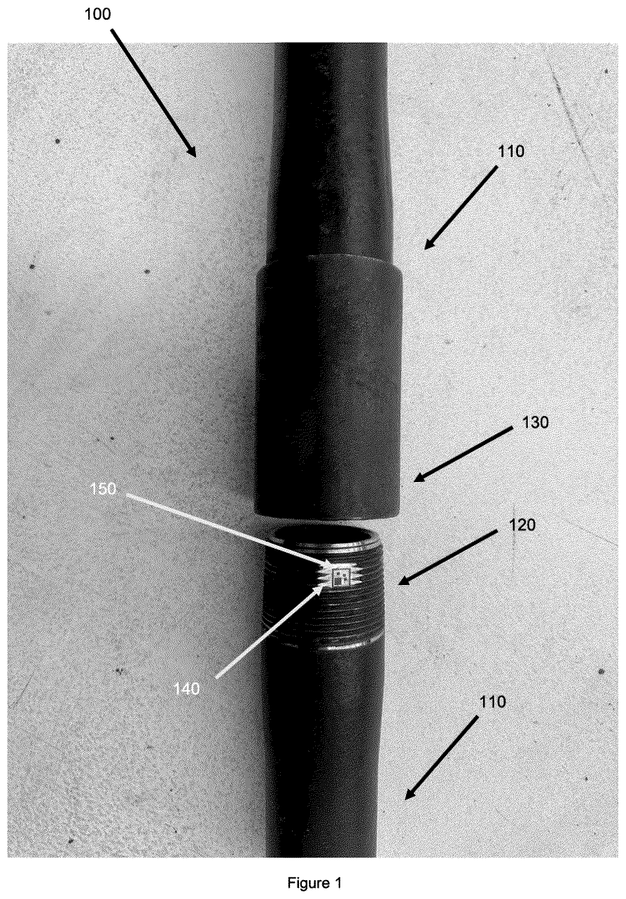

FIG. 1 illustrates a perspective view of part of a downhole tool 100 according to an embodiment of the present invention. The downhole tool (100) is a tubing which comprises an exposed portion (110) configured to be exposed to environmental conditions during use, a protected portion (120) configured to be substantially protected from environmental conditions during use, and a machine-readable identifier (150) located on the protected portion (120) of the downhole tool (100), wherein one or more pieces of data relating to the downhole tool (100) are associated with the identifier.

The exposed portion (110) of the downhole tools (100) forms part of a tube or rod that will be run into the wellbore, extending from the surface down to the desired depth. This exposed portion (110) is in direct contact with the surrounding formations and fluids.

The protected portion (120) of the downhole tools (100) is in the form of a screw-threaded portion. It is envisaged that, when the screw-threaded portion (120) is connected or threaded into another part, such as the complementary screw-threaded portion (130) in FIG. 1, the thread itself is effectively isolated from (and therefore protected from) the surrounding downhole environment.

The machine-readable identifier (150) is a QR code which is a two-dimensional barcode that can store more information compared to traditional barcodes. The QR code is located on the protected portion (120) of the downhole tool (100) and contains relevant data or a link to an electronic database for comprehensive tool information.

As illustrated in FIG. 1, a portion (140) of a screw thread is removed and the machine-readable identifier is located on a relatively smooth or planar surface from which the portion (140) of the screw thread has been removed.

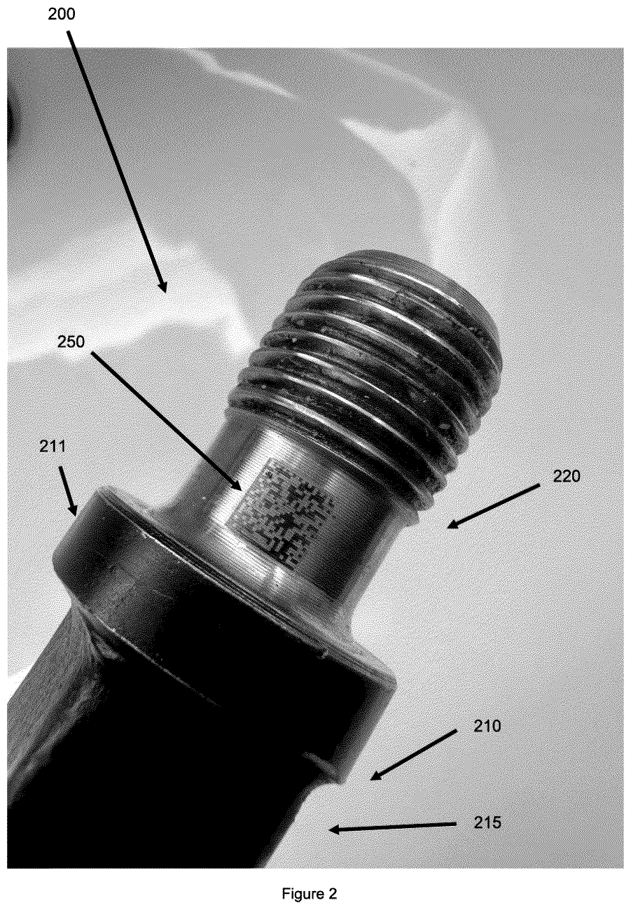

FIG. 2 illustrates a perspective view of part of a downhole tool according to another embodiment of the present invention. The downhole tool (200) is a sucker rod which comprises an exposed portion (210) configured to be exposed to environmental conditions during use, a protected portion (220) configured to be substantially protected from environmental conditions during use, and a machine-readable identifier (250) located on the protected portion (220) of the downhole tool (200), wherein one or more pieces of data relating to the downhole tool (200) are associated with the identifier.

The exposed portion (210) of the downhole tools (200) is the rod body (215) including a flange (211). This exposed portion (210) is in direct contact with the downhole environment during its use in a wellbore.

The protected portion (220) of the downhole tools (200) is in the form of a connection portion including a screw thread. It is envisaged that, when the connection portion (220) is connected or threaded into another part, the connection portion (220) itself is effectively protected from the surrounding downhole environment.

The machine-readable identifier (250) is a QR code which is a two-dimensional barcode that can store more information compared to traditional barcodes. The QR code is located on the protection portion (220) of the downhole tool (200) and contains relevant data or a link to an electronic database for comprehensive tool information.

The machine-readable identifier (250) is applied on the surface of the downhole tool (200) in the protected portion (220) by laser etching. As illustrated in FIG. 1, the machine-readable identifier (250) is located on a relatively smooth or planar surface of the connection portion (220).

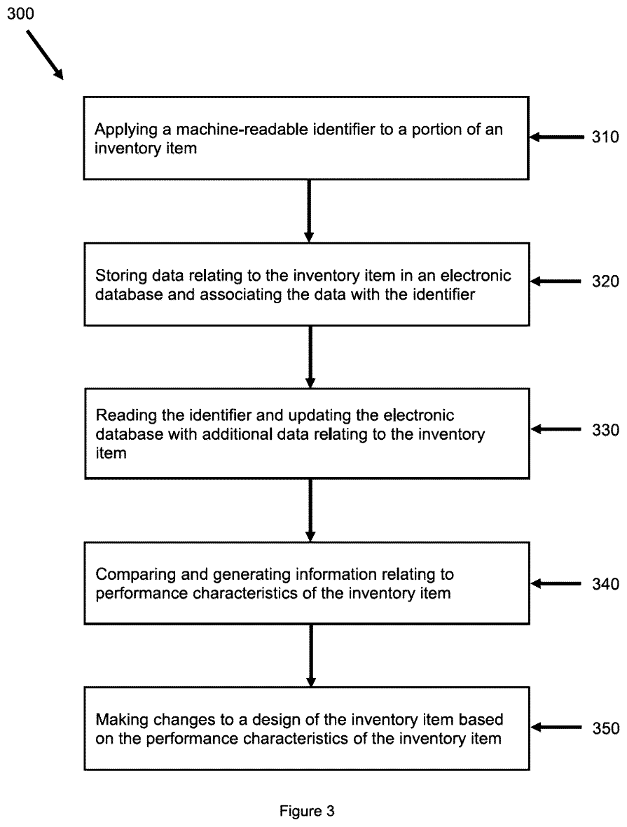

In FIG. 3 there is shown a flowchart of a method (300) for monitoring and/or tracking inventory items according to an embodiment of the invention.

First, a machine-readable identifier is applied to any suitable area of the inventory item (310). Preferably the identifier is to be applied to a protected portion of the inventory item, such that it is protected from various environmental conditions. The machine-readable identifier may be applied to the inventory item using any suitable method. It is envisaged that the machine-readable identifier must be generated before being applied to the downhole tools. Preferably, the machine-readable identifier is a QR code which is attached to the inventory item by laser etching.

Second, one or more pieces of data relating to the inventory item are stored in an electronic database (320). The electronic database may be a relational database management system or a NoSQL database which may be set up locally or on the cloud. Preferably, a unique identifier for the inventory item is generated in order to store the data relating to an inventory item in the electronic database. The database can be accessed manually through a user interface, or automated through integration with other systems, such as scanning devices or IoT sensors. Preferably, the one or more pieces of data relating to the inventory item are linked to the unique identifier in the database. This linkage allows for easy retrieval and updating of the one or more pieces of data based on the unique identifier. This step may happen at the time of the manufacture of the inventory item or at the time the inventory item is acquired by the user. It is envisaged that it should be carried out prior to the first usage of the inventory item.

Third, the unique identifier is read, and the electronic database will be updated with one or more pieces of additional data relating to the inventory item (330). In the case that the unique identifier is a QR code, any QR code scanner device or a compatible mobile device with a built-in QR scanning capability may be used to read the unique identifier. This step may happen when the inventory item is returned to storage after use or during its maintenance period. Alternatively, it may also happen at the replacement of the inventory item. It is envisaged that it ought to happen after the inventory item has been used. The one or more pieces of additional data relating to the inventory may include any relevant information such as maintenance records, inspection dates, usage history, location, or any other pertinent details. Typically, during the database updating, existing data associated with the inventory equipment is retrieved from the database by executing a database query based on the unique identifier to fetch the relevant data. Then, the retrieved data may be modified by incorporating the additional information. Next, the new or modified data may be securely stored in the database, linked to the corresponding inventory equipment.

Fourth, the one or more pieces of data and the one or more additional pieces of data will be compared to generate information relating to the performance characteristics of the inventory item (340). The performance characteristics of inventory items may be any information regarding the properties or use of the inventory items, such as the durability and strength information or maintenance needs. Preferably, this calculation may be carried out by using a computing device which may be a device or machine capable of performing computational tasks, processing data, and executing software programs, such as personal computers, mobile devices, cloud computing devices and so on. It is envisaged that the performance characteristics may be used to determine how the inventory item performed according to its original specifications.

Finally, one or more changes to a design of the inventory item are made based on the performance characteristics (350). The design of the inventory item may be any aspect of the inventory item that can impact the performance, functionality, and reliability in downhole environments such as material selection, durability and reliability, size and weight optimisation, and manufacturability. Typically, the decision to modify the design of the inventory item can be influenced by a combination of technical requirements and business objectives, aiming to optimise the overall value proposition and meet the evolving needs of the industry and end-users.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A downhole tool for use in a gas or oil well, the downhole tool comprising:
an exposed portion configured to be exposed to environmental conditions during use,
a protected portion configured to be substantially protected from environmental conditions during use, and
a machine-readable identifier located on the protected portion of the downhole tool,
wherein one or more pieces of data relating to the downhole tool are associated with the identifier.

2. The downhole tool according to claim 1 wherein the exposed portion comprises:
a tubing or a casing configured for insertion into a wellbore;
a pump mechanism;
one or more sensors, detectors or probes; or
any combination of the above.

3. The downhole tool according to claim 1, wherein, when the downhole tool is a perforating gun, the exposed portion comprises charges or explosives being positioned against a wellbore wall to create perforations.

4. The downhole tool according to claim 1, wherein, when the downhole tool is a drill bit, the exposed portion comprises a cutting structure configured that comes into direct contact with one or more formations being drilled.

5. The downhole tool according to claim 1, wherein the protected portion comprises at least one barrier member configured to create a barrier to reduce or preclude intrusion of well fluids, formation debris, or contaminants into internal components of the downhole tool, the at least one barrier member comprising at least one seal, at least one isolation mechanism, or any combination thereof.

6. The downhole tool according to claim 1, wherein the protected portion is a connection portion.

7. The downhole tool according to claim 6, wherein the connection portion comprises a screw-thread or a coupling.

8. The downhole tool according to claim 1, wherein the machine-readable identifier is a two-dimensional identifier.

9. The downhole tool according to claim 1, wherein the machine-readable identifier is a barcode, QR code or RFID tag.

10. The downhole tool according to claim 1, wherein the machine-readable identifier is located on a relatively smooth or planar surface of the protected portion.

11. The downhole tool according to claim 1, wherein the one or more pieces of data comprise information relating to the specifications of the downhole tool.

12. The downhole tool according to claim 1, wherein the one or more pieces of data comprise:
records of maintenance, inspection, and servicing activities of the downhole tool;
usage history of the downhole tool;
ownership and inventory tracking of the downhole tool; or
any combination thereof.

13. A method for monitoring and/or tracking inventory items, the method comprising the steps of:
applying a machine-readable identifier to a portion of an inventory item that, in use, is substantially protected from environmental conditions;
storing one or more pieces of data relating to the inventory item at a first time in an electronic database and associating the one or more pieces of data with the identifier;
reading the identifier at a second time subsequent to the first time and updating the electronic database with one or more pieces of additional data relating to the inventory item at the second time;
comparing, using a computing device, the one or more pieces of data at the first time with the one or more additional pieces of data at the second time to generate information relating to performance characteristics of the inventory item; and
making, based on the performance characteristics, one or more changes to a design of the inventory item to alter the performance of the inventory item.

14. The method according to claim 13, wherein the inventory item is a downhole tool.

15. The method according to claim 13, wherein the machine-readable identifier is printed onto the inventory item a method of laser etching or marking.

16. The method according to claim 13, wherein the one or more pieces of data relating to the inventory item are stored in the electronic database through integration with scanning devices, IoT sensors, or any combination thereof.

17. The method according to claim 13, wherein the first time is at a point in time prior to the first usage of the inventory item and the second time is at a point in time after the inventory item has been used.

18. The method according to claim 13, wherein the one or more pieces of additional data relating to the inventory includes maintenance records, inspection dates, usage history, location, or any other pertinent details.

19. The method according to claim 13, wherein the one or more changes to the design of the inventory item include changes to one or more of: material selection, structural design, sealing and pressure containment, connection mechanisms, compatibility and interchangeability, fluid flow dynamics, sensing and monitoring, durability and reliability, size and weight optimisation, and manufacturability.

20. A system for monitoring and/or tracking inventory items, the system comprising:
an application device configured to apply a machine-readable identifier to a portion of an inventory item that, in use, is substantially protected from environmental conditions;
an electronic database configured to store one or more pieces of data relating to the inventory item at a first time and associate the one or more pieces of data with the identifier;
a reading device configured to read the machine-readable identifier at a second time subsequent to the first time;
a computing device configured to update the electronic database with one or more pieces of additional data relating to the inventory item at the second time and to compare the one or more pieces of data at the first time with the one or more additional pieces of data at the second time to generate information relating to performance characteristics of the inventory item; and
wherein the computing device is further configured to make, based on the performance characteristics, one or more changes to a design of the inventory item to alter the performance of the inventory item.
